(19) United States
(12) Patent Application Publication
(10) Pub. No.: US 2024/0129139 A1
(43) Pub. Date: Apr. 18, 2024

(54) USER AUTHENTICATION USING TWO INDEPENDENT SECURITY ELEMENTS

(71) Applicants: Freie Universitaet Berlin, Berlin (DE); BUNDESDRUCKEREI GMBH, Berlin (DE)

(72) Inventors: Frank DIETRICH, Berlin (DE); Matthias SCHWAN, Berlin (DE); Marcus FRITSCHE, Berlin (DE); Tim OHLENDORF, Berlin (DE); Marian MARGRAF, Werder (DE)

(73) Assignee: Freie Universitaet Berlin, Berlin (DE)

(21) Appl. No.: 18/547,069

(22) PCT Filed: Feb. 17, 2022
(86) PCT No.: PCT/EP2022/053982

§ 371 Date: Aug. 18, 2023

(30) Foreign Application Priority Data
Feb. 19, 2021 (DE) 10 2021 103 997.5

(51) Int. Cl. H04L 9/32; H04L 9/08

(52) U.S. Cl. CPC H04L 9/3271; H04L 9/0894; H04L 9/3263

(57) ABSTRACT

The invention relates to a method for authenticating a user to an application program (108) installed on a mobile terminal (100). The terminal (100) comprises a first security element (110) associated with an operating system (106) and a second security element (112) associated with the application program (108), which is independent of the first security element (110). The method comprises:
in response to an authentication request from the application program (108), authenticating the user by the operating system (106) using an authentication sensor (118) of the terminal (100) and the first security element (110),
executing a challenge-response method between the first security element (110) and the second security element (112), wherein successful execution of the challenge-response method confirms successful authentication of the user by the operating system (106),
upon successful execution of the challenge-response method, confirming successful authentication of the user to the application program (108) by the second security element (112).

The invention relates to a method for authenticating a user to an application program installed on a mobile terminal, and to a mobile terminal and a system for carrying out the method.

Mobile terminals, such as smartphones, are ubiquitous. They are used in many areas of life and situations to perform a wide variety of tasks in the digital field or with the help of digital tools. The same mobile terminals are used both in areas with low security requirements and in areas with high security requirements.

Consequently, mobile terminals must be able to meet such high security requirements. The security of mobile terminals such as smartphones has therefore become a relevant requirement for the manufacturers of the devices, for the manufacturers of the programs installed on the devices and for providers of services that may be used with the devices. In order to be able to ensure the security of use, secure authentication of the actual user of the end device is of central importance. From the point of view of manufacturers of programs and providers of services, the implementation of a uniformly high security standard for devices from different manufacturers is a particular challenge.

The technical guidelines of the German Federal Office for Information Security “Technical Guideline TR-03159 Mobile Identities Part 1: Security Requirements for eIDAS LoA “substantial””, version 1.0 Draft 2 of 26 Aug. 2019 and “Technical Guideline TR-03159-2 Mobile Identities Amendment A—Provisioning and Personalisation”, version 1.0.0 Draft of 4 Nov. 2020 define implementation-independent requirements for mobile identification scenarios and describe a method that enables identity to be read from an ID card, stored on commercially available SIM cards or secure elements in mobile phones, and subsequently used as an electronic means of identification.

The invention addresses the problem of creating a method for authenticating a user to an application program installed on a mobile terminal.

The problem forming the basis of the invention is solved by the features of each of the independent claims. Embodiments of the invention are described in the dependent claims.

Embodiments comprise a method for authenticating a user to an application program installed on a mobile terminal. An operating system is installed on the terminal. The operating system is configured to control at least one authentication sensor of the terminal for detecting at least one authentication factor of the user. The terminal comprises a first security element associated with the operating system. The first security element comprises cryptographic means for executing a challenge-response method. A private cryptographic key of an asymmetric key pair of the first security element is stored in a protected memory area of the first security element.

A second security element, independent of the first security element and associated with the application program is also provided. The second security element comprises cryptographic means for executing a challenge-response method.

The method comprises:
in response to an authentication request from the application program, authenticating the user through the operating system using the authentication sensor and the first security element,
executing a challenge-response method between the first security element and the second security element, wherein the challenge-response method comprises generating a response by the first security element and validating the response by the second security element, wherein generating the response comprises encrypting a challenge of the second security element by the first security element using the private cryptographic key of the first security element, and wherein validating the response comprises decrypting the response of the first security element by the second security element using a public cryptographic key of the asymmetric key pair of the first security element, wherein successful execution of the challenge-response method confirms successful authentication of the user by the operating system,
on successful execution of the challenge-response method, confirming successful authentication of the user to the application program by the second security element.

For example, the mobile terminal may serve as an authentication token, authorisation token and/or proof of identity, i.e. ID token, for example in electronic business processes. For this purpose, the user may be securely authenticated by the mobile terminal. According to embodiments, the local authentication of the user by the terminal may serve as a basis for further authentication of the user using identity attributes stored, for example, on the terminal. Such further authentication is, for example, authentication by an ID provider service.

The mobile terminal is configured for secure user authentication using the authentication sensor and the operating system or the first security element. The authentication may be based, for example, on a capturing and evaluation of biometric characteristics of the user.

Embodiments may have the advantage that application program manufacturers or the corresponding application programs may rely on the authentication functionality of the mobile terminal for user authentication. The authentication functionality of the terminal using the authentication sensor and the first security element implements a secure binding of the user with the terminal. However, there is no comparable secure binding of the terminal or the user to the corresponding application program. Without further security mechanisms, it may neither be reliably concluded from a use of the application program that there is a use of the terminal device, nor that a certain user is using the terminal device. Such a secure binding may be implemented by using the second security element. The second security element is associated with the application program, for example by installing an applet of the application program in the second security element. In this context, the first security element, which is for example a hardware-based security element of the device manufacturer, provides cryptographic means, such as cryptographic key material and protocols, which may be used for securely providing the authentication results of the terminal device to an application program installed on the terminal device. Thus, the first security element ensures the cryptographic security of the operating system or provides cryptographic security functionality to the operating system. According to embodiments, the first security element may also be, for example, a software-based and/or firmware-based security element of the device manufacturer.

The second security element, which communicates securely with the first security element using the challenge-response protocol, may ensure a secure connection with the first security element. For example, the terminal includes the second security element in addition to the first security element. The secure connection implements a secure connection of the second security element to the first security element and thus to the terminal device and/or its user. This secure connection also allows the second security element to be provided as an external component, for example on an external server.

The second security element comprises, for example, an applet of the application program. The second security element provides cryptographic means, such as cryptographic key material and protocols, which are associated with the application program and are under the control of the application program and/or the manufacturer of the application program. Thus, the second security element ensures the cryptographic security of the application program or provides cryptographic security functionality to the application program. The second security element is, for example, a hardware-, software- and/or firmware-based security element. For example, the second security element comprises an eSIM or an eUICC.

The invention describes a method for the secure authentication of a user on a mobile terminal and the secure authentication of the user by a further security element. The further security element may, for example, be provided on the corresponding mobile terminal, for example with a device manufacturer-independent security application or security applet. For example, the additional security element is provided as an external component, such as on an external server, for use by the application program installed on the mobile terminal.

In particular, it enables secure use of user authentication features, such as biometric features, for authentication to a device manufacturer-independent application program and/or security applet of the application program.

According to embodiments, a challenge-response method is used to authenticate the user to the application program and is executed between the device-specific first security element and the device-independent second security element. The second security element is, for example, an application-specific security element or a security element associated with the application program. For example, a security applet of the application program is installed on the second security element, which is for example an application-specific security applet.

For example, to implement the cryptographically secured connection between the first and second security elements, cryptographic key material is introduced into and/or generated in the device manufacturer-dependent first security element. For example, an asymmetric key pair of the first security element is generated thereon. For example, key material comprising the private cryptographic key of the asymmetric key pair of the first security element is introduced. Further, the introduced key material comprises, for example, the public cryptographic key of the asymmetric key pair of the first security element. This is done, for example, in the course of an initialisation of the mobile terminal. In the case of an insertion of the asymmetric key pair, for example by an initialisation server, the corresponding key pair is created by the initialisation server. Alternatively, the asymmetric key pair is generated by another server and provided to the initialisation server for insertion into the first security element. For example, the public cryptographic key of the first security element is provided as part of a certificate and/or a certificate is provided comprising the corresponding public cryptographic key. For example, the certificate is signed by the initialisation server and/or the further server generating the asymmetric key pair of the first security element. For example, the certificate is part of a PKI comprising the initialisation server and/or the further server generating the asymmetric key pair of the first security element. In this case, the certificate of the public cryptographic key of the first security element is signed with a signature key of the initialisation server and/or furthermore the server generating the asymmetric key pair of the first security element.

The private cryptographic key of the first security element is stored in a protected memory area of the first security element. The protected memory area of the first security element may be, for example, a memory area of a memory of the first security element in the case of a hardware security element. In the case of a firmware or software security element, the protected memory area of the first security element is, for example, a memory area of a memory of the mobile terminal associated with or managed by the first security element. A “protected memory area” is understood here to mean an area of an electronic memory to which access, i.e. read access or write access, is restricted. An access restriction may be, for example, a condition to be fulfilled. The corresponding condition may be, for example, a cryptographic condition, in particular a successful authentication and/or a successful authorisation check. Such a check may, for example, be based on an electronic signature with a signature key. Access may be limited, for example, to being possible only via a processor of the security element or only via a processor of the mobile terminal. For example, the protected memory area are unable to be accessed externally via a bus.

Furthermore, cryptographic key material is introduced into and/or generated in the device manufacturer-independent second security element. For example, cryptographic key material is introduced into and/or generated in a device manufacturer-independent security applet of the second security element. This is done, for example, in the course of initialisation and/or provisioning of the second security element. For example, this is done in the course of initialisation and/or provisioning of the security applet of the second security element associated with the application program. For example, the cryptographic key material introduced comprises the public cryptographic key of the first security element. For example, the cryptographically initialised first security element may introduce or provide the public cryptographic key of the first security element to the second security element and/or the security applet of the second security element. Similarly, the second security element and/or the security applet of the second security element may introduce or provide a cryptographic key of the second security element and/or the security applet of the second security element in the first security element. For example, a provisioning server may introduce the public cryptographic key of the first security element into the second security element and/or the security applet of the second security element.

Thus, embodiments provide a method for authenticating a user by using an authentication method of a mobile terminal for authentication to a further security element, e.g. with an applet or implemented as a remote security element, which is independent and not under the control of the device manufacturer. In this case, authentication of the user of the mobile terminal is enabled by the further security element. Cryptographic key material, in particular a public cryptographic key of the first security element of the device manufacturer, is introduced into the security applet or the remote security element that is independent of the device manufacturer, for example in the course of provisioning.

Furthermore, a challenge-response method is executed between the device-specific first security element and the device-independent second security element to authenticate the user based on a signature method. Here, the device manufacturer-independent second security element sends a nonce to the first security element of the device manufacturer, for example on request. The user authenticates themself, for example by entering a PIN or a biometric feature. Upon successful user authentication, a signature of the nonce is executed. The second security element, which is independent of the device manufacturer, receives the resulting signature as a response and checks it against the public key introduced for example during provisioning.

According to embodiments, a challenge to execute the challenge-response method is generated by the second security element and/or the security applet of the second security element and transmitted to the first security element. The challenge is, for example, a random value, in particular a nonce.

A nonce is any number or string of characters that is intended to be used only once in a cryptographic communication. For example, the nonce is a random or pseudo-random number. A nonce may be used in the course of a challenge-response method to ensure that old responses are unable to be reused in replay attacks. For example, a nonce may be configured to be time-variant, such as by including a timestamp or by using a timestamp to generate the nonce. Furthermore, a nonce may be configured or generated to include a sufficient number of random bits such that the probability of repeating a previously generated value of the nonce is negligible.

For example, the second security element and/or the security applet of the second security element generates the challenge, such as a nonce, and transmits it to the first security element. The first security element initiates an authentication of the user. Upon successful authentication of the user, the first security element signs the challenge using the private cryptographic key of the first security element. The signed challenge is sent as a response to the second security element. The second security element and/or the security applet of the second security element check the response using the public cryptographic key of the first security element. The signed challenge is, for example, a hash value of the challenge encrypted using the private cryptographic key of the first security element. A check of the response includes, for example, decrypting the encrypted hash value using the public cryptographic key of the first security element. The resulting encrypted hash value is compared with the hash value of the sent challenge. If both match, the check and thus the challenge-response method is successful. If the challenge-response method is successful, the second security element and/or the security applet of the second security element knows that the authorised, i.e. successfully authenticated, user is actually using the mobile terminal. The exchange of challenge and/or response may also be cryptographically secured, for example using an encrypted communication channel, for example using end-to-end encryption.

Embodiments may have the advantage of providing a secure method for authenticating a user of the mobile terminal to the second security element and/or the security applet of the second security element and thus to the application program. Thus, the user may securely authenticate themself to the application program through the mediation of the two security elements. The method enables authentication of the user of the mobile terminal using two security elements to the application program or the security applet associated with the application program. The use of two independent security elements makes it possible to use, in addition to the first security element which is associated with the operating system and is, for example, under the control of the manufacturer of the mobile terminal, a further second security element which is independent of the first security element and is, for example, not under the control of the device manufacturer. According to embodiments, a security applet of the second security element associated with the application program is for example under the control of a manufacturer of the corresponding application program. Thus, the method also enables authentication of the user to the application program using the mobile terminal or the authentication means of the mobile terminal. These authentication means comprise, for example, an input device and/or a sensor, such as a biometric sensor of the mobile terminal, as well as the first security element.

Embodiments may have the advantage of implementing simultaneous binding of the user to two independent security elements with mutual secure interleaving of the two security elements on a mobile terminal. For example, the binding of the user is implemented by the first security element having access to reference values for the one or more authentication factors of the user. For example, the corresponding reference values are stored in a memory area of the mobile terminal associated with the first security element. For example, the security element comprises the corresponding memory area. For example, the reference values are stored outside the security element. For example, the reference values are stored in the protected memory area of the first security element. According to embodiments, the reference values are stored in a cryptographically secured form, for example in an encrypted or hashed form. According to embodiments, using the corresponding reference values, the first security element is able to authenticate the user based on authentication factors or authentication data detected with the authentication sensor. Thus, a binding of the user to the first security element may be implemented. The result of the authentication may be forwarded to the second security element in a cryptographically secured manner by means of the challenge-response method, whereby a binding of the user to the second security element and thus the application program may be implemented. As a result, the user may be bound to both security elements at the same time. By means of the challenge-response method and the cryptographic means of the security elements on which it is based, it is thus possible to implement mutual secure interleaving of the two security elements on the terminal device. For example, the cryptographic means comprise an asymmetric key pair of the first security element stored in the first security element and the public cryptographic key of the corresponding key pair stored in the second security element.

An authentication refers to a verification of an asserted property of an entity, such as a user of the mobile terminal. In the course of an authentication, for example, a corresponding proof provided by the user is verified. The entity executes an authentication by contributing to the authentication, i.e. by providing appropriate evidence such as authentication data or authentication factors for verification.

Authentication of the user with regard to the asserted property of authenticity, for example the authenticity of their person or identity, allows the authenticated user to perform further actions. For example, access rights are granted to the user. A successfully authenticated user is considered authentic. A final confirmation of an authentication may include an authorisation.

The user may authenticate themself in various ways. For example, they may present proof of knowledge, such as a PIN or password, proof of possession, such as a cryptographic key, a certificate or an electronic device, and/or proof of characteristics of themself, such as biometric or behavioural characteristics. For example, the corresponding proof is captured by an authentication sensor of the mobile terminal in the form of authentication data of the user and compared by a security element of the mobile terminal with one or more stored reference values. The security element evaluating the captured authentication data is, for example, a security element of the operating system of the mobile terminal. In the event of a sufficient match between the captured authentication data and the stored reference values, the security element confirms a successful authentication of the user. For example, confirmation of successful authentication of the user includes execution of a challenge response method by the confirming security element.

A mobile terminal is understood to be a mobile portable communication device, such as a smartphone, a tablet or a smartwatch.

An authentication sensor is understood to be a sensor for capturing authentication data of the user of the mobile terminal. The authentication data may include, for example, biometric data of the user. The authentication sensor may be configured to capture biometric data of the user, i.e. a biometric sensor. Biometric data may comprise, for example: fingerprint data, body geometry data/anthropometry data such as face, hand, ear geometry data, palm line structure data, vein structure data such as hand vein structure data, iris data, retina data, voice recognition data, nail bed pattern. The authentication sensor may comprise, for example, a camera of the mobile terminal. The authentication data may comprise, for example, a knowledge of the user, such as a PIN or password. The authentication sensor may comprise an input device for inputting authentication data, such as a PIN or password. The input device may comprise, for example, a keyboard and/or a touchscreen.

A challenge-response method represents a secure authentication method of a first entity to a second entity based on knowledge. For example, the first security element is authenticated by the second security element and/or the security applet of the second security element using a challenge-response method. At the same time, the response represents a confirmation of a successful user authentication if the response is generated only under the condition of a successful user authentication by the first security element. Thus, in the case of a successful challenge-response method, the second security element or the security applet not only knows that the user authentication has been confirmed, but also that it has been confirmed by the first security element and is therefore valid.

In the course of a challenge-response method, a first entity presents a task (“challenge”) to a second entity, for which the second entity must provide a correct answer (“response”). By providing the correct response, the second entity proves that it knows a certain piece of information. The advantage of this is that the specific information is not transmitted and thus is unable to be compromised by the data exchange in the course of the challenge-response method. Instead, the specific information may be kept by the second entity as a secret known to it alone.

A challenge-response method may be based on an asymmetric cryptosystem and may serve to prove the possession of a private and thus secret cryptographic key by the second entity to the first entity. Only the second entity knows the corresponding private cryptographic key, which it uses for a cryptographic transformation of the challenge, e.g. of a nonce. The corresponding cryptographic transformation may be, for example, a digital signing. Using a public cryptographic key associated with the private cryptographic key, the first entity may use the response to check whether the second entity actually has knowledge of the private cryptographic key without the first entity itself gaining knowledge of the private cryptographic key during the course of the check.

For example, the first entity generates a random value, such as a nonce, and sends it to the second entity. The second entity uses the secret known to it for a cryptographic transformation of the nonce and sends the result as a response to the first entity for the purpose of authenticating the second entity. If the secret is a private cryptographic key of the second entity, the nonce may be signed using this key. In the course of signing, for example, a hash value of the nonce is calculated and encrypted with the private cryptographic key of the second entity. The first entity, which knows both the nonce and a public cryptographic key of the second entity belonging to the private cryptographic key of the second entity, may perform an inverse calculation, i.e. may decrypt the signed nonce using the public cryptographic key of the second entity. The result of the decryption is, for example, a hash value of the nonce. This decrypted hash value may be compared with the hash value of the sent nonce. For this purpose, a hash function is applied to the corresponding nonce stored with the first entity. If the decrypted hash value matches the hash value of the sent nonce, the challenge-response method is successful and the second entity is successfully authenticated.

In the present case, the second entity is the second security element associated with the application program and the second entity is the first security element associated with the operating system of the mobile terminal.

A security element, also called a “secure element” or “SE”, is understood to be a secured element of a mobile terminal that provides cryptographic means. These cryptographic means are protected against manipulation and are accessible, for example, via cryptographic keys only for authorised services and applications. In particular, the cryptographic means may, for example, only be inserted, added to, changed and/or deleted from the security element by authorised services and applications. A security element thus provides a tamper-proof platform, for example implemented in the form of a secure single-chip microcontroller, on which applets and/or confidential and/or cryptographic data may be stored according to predefined rules and security requirements of reliably identified trusted entities and thus made available to authorised application programs and/or operating systems. A security element may be embedded or integrated, for example introduced nondestructively detachably or fixedly connected, i.e. not non-destructively detachably. The security element may comprise, for example, a SIM, UICC, SmartMicroSD, smartcard, eSE, eSIM or eUICC. For example, cryptographic keys are stored on a security element, i.e. the security element comprises a data vault for cryptographic keys or a “key store”. The cryptographic keys may in particular be cryptographic keys of asymmetric key pairs. Such a key store or security element may also be implemented as part of the main processor, for example in a TEE (Trusted Execution Environment). For example, the first security element may be implemented using a TEE. Security elements are implemented, for example, as hardware and/or firmware. According to embodiments, security elements or key stores may also be implemented as software. For example, two security elements are independent of each other if there is no common entity that is authorised to access both security elements.

An application program, also called an application or app for short, refers to a computer program that provides, supports and/or enables the processing of non-system-technical functionality.

An applet is a computer program that is not operated as an independent application program. The term “applet” is composed of the words “application” and “snippet”.

An operating system denotes a computer program or a set of computer programs that provide, support and/or enable the processing of system functions. System resources are made available by an operating system. System resources refer to system elements or hardware components of a computer that are required by processes for correct execution.

A “communication interface” is understood here to mean, for example, an interface via which data may be received and sent, wherein the communication interface may be configured as contact-based or contactless.

Communication may take place via a network, for example. A “network” is understood here to mean any transmission medium with a connection for communication, in particular a local connection or a local network, in particular a Local Area Network (LAN), a private network, in particular an intranet, and a digital private network (Virtual Private Network—VPN). For example, a computer system may have a standard radio interface to connect to a WLAN. Further, it may be a public network, such as the Internet. Depending on the embodiment, this connection may also be established via a mobile communications network.

Contactless communication is possible, for example, by means of Near Field Communication (NFC). This is, for example, a communication based on RFID technology for the contactless exchange of data by electromagnetic induction using loosely coupled coils over short distances. NFC may be implemented, for example, according to one of the standards ISO 14443, 18092, 21481, ECMA 340, 352, 356, 362 or ETSI TS 102 190.

A “processor” is understood here and in the following to mean a logic circuit that is used to execute program instructions. The logic circuit may be implemented on one or more discrete components, in particular on a chip. A processor comprises, for example, an arithmetic unit, a control unit, registers and data lines for communication with other components. In particular, a “processor” is understood to mean a microprocessor or a microprocessor system comprising several processor cores and/or several microprocessors.

A “memory” is understood here to mean in particular a non-volatile memory. A “nonvolatile memory” is understood here to mean, for example, an electronic memory for the permanent storage of data. A non-volatile memory may be configured as a non-changeable memory, which is also referred to as a read-only memory (ROM), or as a changeable memory, which is also referred to as a non-volatile memory (NVM). In particular, this may be an EEPROM, for example a Flash EEPROM, referred to as Flash for short. A non-volatile memory is distinguished by the fact that the data stored on it is retained even after the power supply is switched off.

A public key infrastructure (PKI) is a system for issuing, distributing and verifying digital certificates. In an asymmetric cryptosystem, a digital certificate serves to confirm the authenticity of a public key and its permissible scope of application and validity. The digital certificate is itself protected by a digital signature of which the authenticity may be verified with the public key of the issuer of the certificate. To verify the authenticity of the issuer key, a digital certificate is again used. In this way, a chain of digital certificates may be built up, each of which confirms the authenticity of the public key with which the preceding certificate may be verified. Such a chain of certificates forms a so-called validation path or certification path. The participants of the PKI must be able to rely on the authenticity of the last certificate, the so-called root certificate, and the key certified by this certificate without another certificate. The root certificate is managed by a so-called root certification entity, the authenticity of which, which is assumed to be secure, forms the basis of the authenticity of all certificates of the PKI.

A “certificate” is understood here to be a digital certificate, which is also called a public key certificate. Such certificates based on asymmetric key pairs are used to realise a so-called public key infrastructure (PKI). Such a certificate is structured data that is used to assign a public key of an asymmetric cryptosystem to an identity, such as a person or a device. For example, a certificate may contain a public key and may be signed. For example, the certificate may conform to the X.509 standard or another standard. For example, the certificate may be a Card Verifiable Certificate (CVC) certificate, which is a public key certificate stored in a compact format.

Digital certificates are a proven means of proving authorisations when securing electronic communication using asymmetric cryptographic methods. Certificates are structured data that document the authenticity and/or other properties/authorisations of the owner of a public key (signature verification key) and confirm them by an independent, credible authority (certification service provider/CSP), generally the certification authority awarding the certificate. Certificates are usually made available to a wide range of people to enable them to check electronic signatures for authenticity and validity.

A certificate may be associated with an electronic signature if the private key associated with the public key was used to generate the electronic signature to be verified. By making a certificate available to the general public in association with a public key, a CSP enables users of asymmetric cryptosystems to associate the public key with an identity, such as a person, organisation, energy or computer system.

Asymmetric key pairs are used for a variety of cryptosystems and also play an important role in the signature of electronic documents. An asymmetric key pair consists of a public key, which is used to encrypt and/or decrypt data and may be passed on to third parties, and a private key, which is used to encrypt and/or decrypt data and must usually be kept secret. The public key allows anyone to encrypt data for the private key holder and to verify digital signatures created with the private key. A private key enables its holder to decrypt data encrypted with the public key or to create digital signatures. A signature created with a private key may be verified with the associated public key.

The creation of a digital signature, hereinafter also referred to simply as a “signature”, is a cryptographic method in which a further data value, referred to as a “signature”, is calculated for any data. A signature may, for example, be a hash value of the source data encrypted with a private cryptographic key.

An “encrypted end-to-end connection” or an “encrypted end-to-end transmission channel” is understood here to be a connection between a sender and a receiver with end-to-end encryption, in which data to be transmitted is encrypted by the sender and only decrypted again by the receiver. The encryption of transmitted data thus takes place across all transmission stations, so that intermediate stations are unable to gain knowledge of the content of the transmitted data due to the encryption. The connection is cryptographically secured by the encryption in order to prevent spying and/or manipulation of the transmission, wherein a so-called secure messaging method may be used for this purpose. For example, end-to-end encryption is based on two symmetric cryptographic keys, wherein a first of the symmetric keys is used to encrypt messages and a second of the symmetric keys is used to authenticate the sender of the message.

Embodiments may have the advantage of enabling secure management of digital identities using a mobile terminal. For this purpose, the application program may be provided as an ID application program for managing digital identities or identity attributes belonging to digital identities or defining digital identities. For example, a secure application program or application for managing digital identities is provided, which is hereinafter referred to as an ID application program.

The ID application program, which is installed and executed on the mobile terminal, is associated with the second security element. For example, the ID application program is associated with a security applet that is installed and executed on the second security element of the mobile terminal. The mobile terminal with the digital identities managed by the ID application program may be used to identify and authenticate, to transmit identity data, and to support declarations of intent in the mobile context.

According to embodiments, the digital identity may comprise an officially recognised identity, such as a digital identity created on the basis of an official identification document, such as an identity card or passport.

The digital identity of a user is unambiguous, i.e. unique and unmistakable. It is defined on the basis of characteristics, so-called identity attributes. A digital identity includes, for example, personal data. Personal data refers to data that enables the identification of a person or may be assigned to a person to whom the personal data relates.

A user may have a plurality of different, application-specific digital identities. These digital identities may meet different security requirements.

According to embodiments, a digital identity stored on the mobile terminal and provided or managed by the ID application program may be used to identify and authenticate the user of the mobile portable device without additional hardware alongside the mobile terminal.

Identity attributes are requested, for example, by service providers for online services. According to embodiments, the identity attributes required by a service provider for its online service are transmitted in an encrypted and authentic manner. For example, authorisation certificates are used to regulate who may access which identity attributes or has read authorisation for them. For example, the required identity attributes are read out by an ID provider authorised to do so by means of an authorisation certificate and made available to the requesting service provider. According to embodiments, the ID provider only provides the requesting service provider with a confirmation of the requested identity attribute(s).

User consent to the use of the identity attributes and/or user authentication is achieved, for example, by authentication, i.e. by checking one or more authentication factors, such as password, PIN, or a biometric feature, for example fingerprint or facial recognition.

According to embodiments, the challenge-response method comprises generating a response and validating the response. Generating the response comprises signing the challenge and validating the response comprises signature verification.

Embodiments may have the advantage that signing may prove knowledge of the first security element, for example in the form of the signature key used for signing, i.e. a private cryptographic key, without the need to transmit the corresponding knowledge for proof itself. For example, since only the first security element has access to the private cryptographic key used for signing, only it may create the signature, which may be successfully checked for validity with the corresponding public cryptographic key. If the signature check with the corresponding public cryptographic key is successful, the origin of the signature is proven. Thus, the first security element may be authenticated in an efficient, effective and secure manner by the second security element and/or the security applet of the second security element using the challenge-response method. Since the prerequisite for sending the response is a successful authentication of the user by the first security element, the successful challenge-response method also confirms and proves the successful user authentication. Thus, the challenge-response method authenticates the user to the second security element and/or the security applet of the second security element using the first security element.

If a cryptographic key of sufficient length is used for the signature, this may have the advantage of increasing the entropy and thus the security of the authentication method.

According to embodiments, the public cryptographic key of the first security element is provided to the second security element as part of a certificate. According to embodiments, the second security element comprises a certificate comprising the public cryptographic key of the asymmetric key pair of the first security element.

According to embodiments, the certificate is a public key infrastructure (PKI) certificate.

According to embodiments, the terminal comprises the second security element.

According to embodiments, the second security element is provided by an external server.

Embodiments may have the advantage of providing a means for using a remote second security element, i.e. a remote security element, on an external server for providing cryptographic functions to an application program installed on a mobile terminal. A corresponding security element comprises, for example, cryptographic keys for executing cryptographic protocols such as encryptions, decryptions and/or signatures. A corresponding security element does not have to be implemented on the mobile terminal itself, but may be provided to the mobile terminal by a server that communicates with the mobile terminal via a network.

For example, the remote security element may be used for encrypted communication between the application program installed on the mobile terminal and the computer system reading it. For example, one or more electronic identities are stored on the mobile terminal. The electronic identities each comprise one or more identity attributes. The corresponding identity attributes are stored, for example, in encrypted form on the mobile terminal. For example, the mobile terminal does not have one or more cryptographic keys for decrypting the encrypted identity attributes. For example, the identity attributes of different electronic identities are encrypted with different cryptographic keys. The cryptographic key or keys for decrypting the identity attributes are stored, for example, in the remote security element. Thus, the mobile terminal, and thus the user of the mobile terminal, has sovereignty over the identity attributes, while their cryptographic security is provided by the remote security element. Thus, on the one hand, the cryptographic security of the identity attributes may be outsourced to a remote server, while the user still retains control over the identity attributes, i.e. the user may decide which identity attributes are made available to which computer system for readout. Without involving the mobile terminal and thus the user of the mobile terminal, no identity attributes may be made available.

If identity attributes are to be read out, the server receives the corresponding identity attributes to be read out from the application program installed on the mobile terminal that manages the associated electronic identity. The remote second security element of the server decrypts the identity attributes to be read using a cryptographic key associated with the electronic identity. The cryptographic key is, for example, a symmetric cryptographic key stored in the remote security element. For example, the security module is implemented in the form of a hardware security module (HSM) of the server. For example, the corresponding security element may comprise a security applet associated with the corresponding application program. A sub-security domain of the security element associated with the electronic identity stores, for example, the corresponding cryptographic key for decrypting the identity attributes. The decrypted identity attributes to be read out are encrypted by the second security element using an ephemeral symmetric key. The corresponding ephemeral symmetric cryptographic key was generated, for example, in the course of establishing a cryptographically secured communication channel between the remote second security element and the reading computer system. The corresponding ephemeral symmetric cryptographic key is stored in the remote second security element, for example, to secure communication with the reading computer system. The communication between the remote second security element or the server on the one hand and the reading computer system on the other hand takes place, for example, via the application program or the mobile terminal. The server sends encrypted identity attributes to the reading computer system using the ephemeral symmetric key.

Embodiments may have the advantage that hardware-based security of electronic identities may be provided on hardware independent of the mobile terminal, i.e. using the remote second security element (“remote secure element”), independent of the hardware and software equipment of the mobile terminal itself. For example, integrity, authenticity, imputability of the electronic identities may be provided, e.g. by authentication using the remote secure element. Furthermore, decentralised storage of the identity data on the mobile terminal may be enabled, in which case the user of the mobile terminal retains control over the identity attributes of their electronic identities. Furthermore, a secure verification of the electronic identities on the mobile terminal may be ensured by means of suitable cryptographic methods. Lastly, a variable and exchangeable use of authentication methods may be made possible.

According to embodiments, the second security element comprises a security applet associated with the application program. The security applet comprises cryptographic means for executing a challenge-response method. Successful authentication of the user to the application program is confirmed by the security applet.

According to embodiments, the method further comprises providing the asymmetric key pair. The asymmetric key pair may be generated, for example, by the first security element.

According to embodiments, providing the asymmetric key pair of the first security element comprises:
generating the asymmetric key pair by the first security element,
transmitting the public cryptographic key of the asymmetric key pair of the first security element to the second security element.

Embodiments may have the advantage that the private cryptographic key of the symmetric key pair generated by the first security element does not leave the first security element and may be shared in a secure manner with the security applet. This may ensure that only the first security element is able to use the private cryptographic key.

According to embodiments, the first security element sends the public cryptographic key of the asymmetric key pair of the first security element directly to the second security element.

According to embodiments, the mobile terminal comprises a communication interface for communication via a network. Transmitting the public cryptographic key of the asymmetric key pair of the first security element comprises:
sending the public cryptographic key of the asymmetric key pair of the first security element to the application program,
forwarding the public cryptographic key of the asymmetric key pair of the first security element from the application program using the communication interface via the network to an external provisioning server having write authorisation to write to a memory area of the second security element,
validating the write authorisation of the provisioning server to write to the memory area of the second security element,
upon successful validation of the write authorisation of the provisioning server, granting write access of the external provisioning server via the communication interface to the memory area of the second security element,
writing the public cryptographic key of the asymmetric key pair of the first security element into the memory area of the second security element.

Embodiments may have the advantage of increasing the security of the second security element or the security applet of the second security element. For example, external cryptographic data, such as the public cryptographic key of the first security element, may only be introduced into the second security element by an external entity that may prove authorisation to do so, for example using an authorisation certificate. In one embodiment, the external entity is, for example, the provisioning server. For example, the external entity is under the control of the developer/manufacturer of the application program and/or security applet. For example, the external entity was a trusted third party entity independent of the application program developer/manufacturer and authorised by the application program developer/manufacturer to introduce external key material and/or external keys into the second security element and/or the security applet, for example on behalf of the application program developer/manufacturer and/or with the consent of the application program developer/manufacturer. In order to be able to introduce external key material and/or external keys into the security applet, possession of and/or access to the mobile terminal is not sufficient, for example. Rather, additional control over an external entity independent of the mobile terminal is required.

According to embodiments, providing the asymmetric key pair of the first security element is performed in the course of initialising the first security element by an external initialisation server, wherein the initialisation server comprises write authorisation to initialise the first security element,
wherein the initialisation comprises:
   generating the asymmetric key pair of the first security element by the first security element,
   validating the write authorisation of the initialisation server to initialise the second security element,
   upon successful validation of the write authorisation of the initialisation server, granting write access of the external initialisation server via the communication interface to the second security element,
   initialising the first security element,
   writing the asymmetric key pair of the first security element into the initialised memory area.

Embodiments may have the advantage that the security of the first security element may be increased, as there are for example only two ways to introduce cryptographic key material into the first security element: either the corresponding cryptographic keys are generated by the first security element itself or they are introduced by an external entity that may prove an authorisation to do so, for example using an authorisation certificate. The corresponding external entity is, for example, an initialisation server that introduces the corresponding key material, such as an asymmetric key pair, into the first security element during the course of initialisation of the latter. For example, the external entity is under the control of the device manufacturer of the mobile terminal. For example, the external entity is a trusted third party, independent of the device manufacturer of the mobile terminal, which has been authorised by the developer/manufacturer of the application program to introduce external key material and/or external keys into the first security element, for example on behalf of the device manufacturer and/or with the consent of the device manufacturer. In order to be able to introduce external key material and/or external keys into the first security element, possession of the mobile terminal and/or access to the mobile terminal is not sufficient, for example. Rather, control over an external entity independent of the mobile terminal is additionally required.

For example, in the course of producing the asymmetric key pair, a certificate, such as a PKI certificate, is also generated with or for the public cryptographic key of the first security element. For example, the public cryptographic key of the first security element is provided by the initialisation server or first security element to a provisioning server for insertion into the second security element.

According to embodiments, the method further comprises:
sending the public cryptographic key of the asymmetric key pair of the first security element from the external initialisation server to the external provisioning server, which has write authorisation to write to a memory area of the second security element,
validating the write authorisation of the provisioning server to write to the memory area of the second security element,
upon successful validation of the write authorisation of the provisioning server, granting write access of the external provisioning server via the communication interface to the memory area of the second security element,
writing the public cryptographic key of the asymmetric key pair of the first security element into the memory area of the second security element.

According to embodiments, the method further comprises initialising the security applet in the second security element by an external initialisation server. The initialisation server comprises a write authorisation to initialise the security applet in the second security element. The initialisation comprises:
validating the write authorisation of the initialisation server to initialise the security applet in the second security element,
upon successful validation of the write authorisation of the initialisation server, granting a write access of the external initialisation server via the communication interface to the second security element,
initialising the memory area of the second security element assigned to the security applet,
writing an asymmetric key pair of the security applet into the initialised memory area.

Embodiments may have the advantage that the security of the second security element or the security applet of the second security element may be increased, as there are for example only two ways to introduce cryptographic keys into the security applet: either the corresponding cryptographic keys are generated by the security applet itself or they are introduced by an external entity that may prove an authorisation to do so, for example using an authorisation certificate. For example, the external entity is under the control of the developer/manufacturer of the application program and the security applet. For example, the external entity was a trusted third party independent of the application program developer/manufacturer, authorised by the application program developer/manufacturer to introduce external key material and/or external keys into the security applet, for example on behalf of the application program developer/manufacturer and/or with the consent of the application program developer/manufacturer. In order to be able to introduce external key material and/or external keys into the security applet, possession of the mobile terminal and/or access to the mobile terminal is not sufficient, for example. Rather, additional control over an external entity independent of the mobile terminal is required. In one embodiment, the external entity is, for example, the initialisation server. The initialisation server may be dependent on the provisioning server, identical to it and/or independent of it. For example, the initialisation server of the second security element and/or the security applet of the second security element is an initialisation server different from the initialisation server of the first security element. For example, the second security item initialisation server and/or the second security item security applet is an initialisation server of the application program developer/manufacturer or an entity authorised by the application program developer/manufacturer, whereas the first security item initialisation server is an initialisation server of the device manufacturer.

Embodiments may have the advantage that the public cryptographic key of the asymmetric key pair of the first security element generated by or for the first security element may be shared in a secure manner with the second security element.

According to embodiments, communication in the course of the challenge-response method between the first security element and the second security element, for example the security applet, takes place via the application program.

Embodiments may have the advantage that the application program may use the challenge-response method itself. According to embodiments, the application program may thereby authenticate itself to the second security element and/or security applet. For example, the second security element and/or security applet sends the challenge to the application program, which responds in the course of the challenge-response method with a response provided by the first security element. This response serves as proof of ownership. For example, the response includes the challenge encrypted with the private cryptographic key of the first security element and thus proves ownership of the corresponding private cryptographic key. From the point of view of the second security element and/or security applet, the application program may authenticate itself to the second security element and/or security applet by using the response or is authenticated by the second security element and/or security applet. The private cryptographic key of the first security element thus provides an authentication key for authenticating the application program. The public cryptographic key of the first security element thus represents an authentication key for authenticating the application program. For example, the private cryptographic key is stored in a protected memory area of the first security element. Access to the private cryptographic key in the protected memory area of the first security element requires, for example, successful user authentication to the first security element using the authentication sensor. Access is therefore protected by the user authentication. After successful user authentication by the first security element and successful authentication of the application program using the response provided by the first security element, the second security element may be used and/or the security applet of the second security element may be accessed by and/or through the application program. For example, the second security element and/or the security applet of the second security element may be invoked by an external server via a client module of the application program. In this context, the second security element may be provided, for example, on the mobile terminal or on a further external server. According to embodiments, a prerequisite for calling the second security element and/or the security applet of the second security element by the external server is a successful proof of authorisation of the server for calling to the application program and/or to the second security element or the security applet of the second security element. An appropriate proof of authorisation may include, for example, the use by the external server of an authorisation certificate that proves the authorisation of the external server to access the second security element and/or the security applet of the second security element.

According to embodiments, access to the second security element and/or the security applet of the second security element associated with the application program is only possible via the application program. Embodiments may have the advantage that the security of the second security element and/or the security applet of the second security element may thus be increased and the latter may be protected against unauthorised access.

According to embodiments, the challenge-response method comprises:
sending the challenge of the second security element, for example the security applet, to the application program,
forwarding the challenge from the application program to the first security element,
upon successful authentication of the user by the operating system, generating the response by the first security element,
sending the response from the first security element to the application program,
forwarding the response from the application program to the second security element, for example the security applet,
validating the decrypted response through the security applet.

Embodiments may have the advantage that the application program may use the challenge-response method itself, for example for authentication to the second security element and/or the security applet of the second security element. If access to the second security element and/or the security applet of the second security element is only possible via the application program, the security of the second security element and/or the security applet of the second security element may be increased and the latter may be protected against unauthorised access.

According to embodiments, the authentication request comprises the challenge and the generation of the response is in response to the successful authentication of the user. Embodiments may have the advantage that the challenge-response process may be implemented in an efficient and effective manner. At the same time, the response proves and confirms the successful authentication of the user.

According to embodiments, the authentication of the user comprises:
detecting at least one authentication factor of the user using the authentication sensor,
validating the captured authentication factor using the first security element.

Embodiments may have the advantage of providing an effective and secure method for authenticating the user.

According to embodiments, confirming successful authentication of the user comprises sending an authentication confirmation of the second security element, for example the security applet, to the application program upon successful validation of the response.

Embodiments may have the advantage of confirming the authentication to the application program. Further, the application program may use the authentication confirmation as evidence of successful authentication. According to embodiments, the presence of an authentication confirmation is a prerequisite for executing one or more functions of the application program.

According to embodiments, the application program is an ID application program configured to manage one or more identity attributes associated with the user.

Embodiments may have the advantage that the one ID application program may provide one or more digital identities of the user based on the identity attributes. By authenticating the user to the ID application program, a cryptographically secured link between the real world, i.e. the person of the user, and the digital world, i.e. the digital identity attributes assigned to the user, may be implemented using the first security element and the second security element and/or the security applet of the second security element.

According to embodiments, a use of the identity attributes requires a successful authentication of the user of the mobile terminal.

For example, the identity attributes define a digital identity. This digital identity may be based on and/or derived from a primary identity provided by an ID token. According to embodiments, the digital identity may be a copy of the primary identity.

According to embodiments, the digital identity provided by the mobile terminal may be used to authenticate and/or identify the user without any further user-side hardware.

According to embodiments, the identity attributes are read from an ID token that provides a primary identity comprising the identity attributes. The readout may be contactless, for example, using NFC communication. In this case, the mobile terminal comprises, for example, a communication interface for contactless communication, such as NFC communication. An ID token is understood here to be a device, in particular an electronic device such as an electronic ID document, which provides a primary identity comprising identity attributes for identification purposes. The device may be, for example, a so-called USB stick, a chip card or a document. In particular, an ID token is understood to be a portable electronic device comprising a processor for executing program instructions and a memory for storing program instructions, wherein the identity attributes are stored in the memory and, using the processor, may be provided on request for verification purposes via a communication interface of the ID token. The communication interface is a contactless communication interface, for example.

A document is understood to mean in particular an identification, value or security document, in particular a sovereign document with electronic means, such as processor, memory and communication interface, in particular a paper-based and/or plastic-based document, such as an electronic identification document, in particular passport, identity card, visa, driving licence, vehicle registration certificate, vehicle title, health card, or a company ID card, or another ID document, a chip card, means of payment, in particular bank note, bank card or credit card, consignment note or other proof of authorisation. In particular, the ID token may be a machine-readable travel document, such as those standardised by the International Civil Aviation Organization (ICAO) and/or the BSI.

According to embodiments, the ID token does not have its own energy supply. Instead, the energy source may be a device for harvesting energy, which is transmitted from the mobile terminal to the ID token, for example using communication interfaces configured as RFID antennas.

According to embodiments, the ID application program is configured to send one or more of the identity attributes of the user to another terminal. Embodiments may have the advantage that sending the identity attributes of the user requires successful authentication of the user of the mobile terminal. Thus, secure use of the identity attributes may be ensured solely by the user themself and/or with their consent.

The identity attributes may be sent, for example, using a wireless communication connection such as an NFC connection, a Bluetooth connection or a WiFi connection.

According to embodiments, the ID application program is configured to send one or more of the identity attributes of the user using the communication interface via a network to an ID-provider server for providing said attributes to a service-provider server and/or for confirmation by the service-provider server.

Embodiments may have the advantage of ensuring that the identity attributes of the user are provided securely, wherein providing these attributes requires user authentication, and wherein these attributes are provided only by an authorised external entity, i.e. the ID provider.

Sending identity attributes to the ID-provider server requires, for example, authentication of the ID-provider server, proof of authorisation on the part of the ID-provider server to access the identity attributes, establishment of an encrypted channel for secure transmission of the identity attributes and/or assurance of the authenticity of the transmitted identity attributes. For this purpose, the second security element and/or the security applet of the second security element provides cryptographic means. The cryptographic means connprise, for example, an asymmetric key pair of the second security element or of the security applet, in particular a private cryptographic key of the second security element or of the security applet, and cryptographic protocols for calculating ephemeral session keys, in particular symmetric ephemeral session keys.

The authenticity of the transmitted identity attributes may be ensured, for example, by using a Message Authentication Code (MAC). The cryptographic protocols provided by the second security element and/or by the security applet of the second security element are configured, for example, to calculate a MAC, i.e. comprises a MAC algorithm. A MAC is calculated using, for example, a MAC algorithm to which data to be protected, i.e. the identity attributes, and a cryptographic key, for example a symmetric cryptographic key, are provided as input data. Using this input data, the MAC algorithm calculates a checksum, which serves as a MAC. For example, block ciphers or hash functions may be used to calculate a MAC. For example, an HMAC (Keyed-Hash Message Authentication Code) may be used as a MAC, for the construction of which a cryptographic hash function, such as the Secure Hash Algorithm (SHA), and a cryptographic key, such as a symmetric cryptographic key, are used.

To secure a data transmission, for example a transmission of identity attributes, a cryptographic key, for example a symmetric cryptographic key, is agreed between the sender, for example the second security element and/or the security applet of the second security element, and the receiver, for example the ID-provider server. The sender uses this cryptographic key to calculate a MAC of the data to be transmitted and sends the calculated MAC together with the data to be transmitted to the receiver. The transmitted data is thereby encrypted, for example, with the same cryptographic key. The receiver decrypts the received data using the cryptographic key and in turn calculates a MAC for the received data using the cryptographic key. The receiver compares the result with the received MAC. In case of a match between the calculated MAC and the received MAC, the integrity check is successful and the received data is considered authentic.

In the case of a MAC, both sender and receiver must have knowledge of the cryptographic key used, in contrast to the use of pure hash functions or signatures. In the case of pure hash functions, for example, no cryptographic keys are used. If the hash functions are public, anyone may calculate the hash value, especially for manipulated messages. In the case of a signature, only the signing party knows the private cryptographic key, i.e. signature key, of an asymmetric key pair used to create the signature. The signature recipient only has the public key, i.e. signature verification key, of the asymmetric key pair used for the signature. The signature recipient may therefore verify the signature using the signature verification key, but is unable to calculate it themself.

For example, a digital identity provided by the mobile terminal may be used to access a web service provided by a service-provider server. For example, the ID application program may be used to register with the web service. To do this, the user accesses a website of the service provider using a mobile browser of the mobile terminal or contacts the service provider using an application program of the service provider installed on the mobile terminal. For example, the user clicks on a login button. For example, the user selects to register using the ID application program. The ID application program is then launched and the user is prompted by the ID application program to authenticate to the ID application program using the mobile terminal. For this purpose, the user uses the mobile terminal with the first security element and provides it with authentication factors or authentication data for authentication using the authentication sensor. Upon successful authentication of the user to the ID application program, a secure connection is established between the second security element and/or the security applet of the second security element on the one hand and the service-provider server on the other hand. For example, the secure connection is an encrypted connection, in particular a connection encrypted by means of end-to-end encryption. For example, the establishment of the secure connection comprises a mutual authentication of the reading service-provider server and the second security element or security applet of the second security element, i.e. an authentication of the reading server by the second security element and/or by the security applet of the second security element as well as an authentication of the second security element and/or the security applet of the second security element by the reading server. Via this connection, which is secured by means of encryption, for example, identity attributes required for registration, such as personal data of the user, such as first name, surname, date of birth, address, etc., may be transmitted to the service-provider server. According to embodiments, the user sees what kind of personal data is to be forwarded to the service-provider server and may consent to the transmission of this data by means of user authentication. In case of a successful user verification, the required identity attributes are sent to the service-provider server and the user is redirected to an authenticated web session with the service provider.

According to embodiments, the ID application program comprises an ID management module that manages a plurality of ID profiles, wherein each of the ID profiles is associated with an independent security applet in the second security element.

Embodiments may have the advantage that a plurality of different ID profiles and thus digital identities of the user may be managed by the ID application program. Each of these digital identities of the user is assigned its own security applet independent of the other security applets. Thus, each digital identity is secured by its own security applet. For example, one or more of the digital identities are digital identities of the user that the ID application program manages for other entities, such as other application programs and/or service providers. For example, different security levels may be assigned to the different ID profiles or digital identities, which have to be fulfilled by the respective assigned security applet. Furthermore, different authentication factors may be defined in the first security element for different ID profiles or digital identities and assigned to the respective profile or the security applet assigned to the respective profile. Thus, in this case, the user must prove different authentication factors for different digital identities for successful authentication. The individual authentication factors and/or their combinations may fulfil different security levels, for example due to different entropies.

According to embodiments, each of the ID profiles is associated with a set of one or more identity attributes. For example, the sets of identity attributes originate from an ID token.

Embodiments further comprise a system. The system comprises a mobile terminal for authenticating a user to an application program installed on a mobile terminal. The mobile terminal comprises a processor, the terminal has, installed thereon, an operating system configured to control at least one authentication sensor of the terminal to detect at least one authentication factor of the user. The terminal further comprises a first security element associated with the operating system, which comprises cryptographic means for executing a challenge-response method. A private cryptographic key of an asymmetric key pair of the first security element is stored in a protected memory area of the first security element.

The system further comprises a second security element, independent of the first security element, which comprises cryptographic means for executing a challenge-response method.

The processor is configured to execute a method for authenticating a user to an application program installed on a mobile terminal, comprising:
in response to an authentication request from the application program, authenticating the user through the operating system using the authentication sensor and the first security element,
executing a challenge-response method between the first security element and the second security element, wherein the challenge-response method comprises generating a response by the first security element for validation by the second security element, wherein generating the response comprises encrypting a challenge of the second security element by the first security element using the private cryptographic key of the first security element for validation by decrypting the response of the first security element by the second security element using a public cryptographic key of the asymmetric key pair of the first security element, wherein successful execution of the challenge-response method confirms successful authentication of the user by the operating system,
upon successful execution of the challenge-response method, confirming successful authentication of the user to the application program by the second security element.

According to embodiments, the mobile terminal and/or the system is configured to perform each of the previously described embodiments of the method for authenticating the user to the application program installed on the mobile terminal.

According to embodiments, the terminal comprises the second security element.

According to embodiments, the terminal comprises a communication interface for communication via a network, wherein the system further comprises a server providing the second security element.

According to embodiments, the system further comprises an initialisation server. The initialisation server is configured to initialise the first security element and comprises a write authorisation to initialise the first security element.

The initialisation comprises:
generating the asymmetric key pair of the first security element by the first security element,
validating the write authorisation of the initialisation server to initialise the second security element,
upon successful validation of the write authorisation of the initialisation server, granting write access of the external initialisation server via the communication interface to the second security element,
initialising the first security element,
writing the asymmetric key pair of the first security element into the initialised memory area.

According to embodiments, the system is configured to perform any of the previously described embodiments of initialising the first security element.

According to embodiments, the system comprises a further initialisation server for initialising the second security element and/or a security applet in the second security element, which comprises a write authorisation for initialising the second security element and/or the security applet in the second security element.

The initialisation comprises:
validating the write authorisation of the further initialisation server to initialise the security applet in the second security element,
upon successful validation of the write authorisation of the further initialisation server, granting write access of the further external initialisation server via the communication interface to the second security element,
initialising the memory area of the second security element assigned to the security applet,
writing the first asymmetric key pair into the initialised memory area.

According to embodiments, the system is configured to perform any of the previously described embodiments of the method for initialising the second security element and/or the security element of the second security element.

According to embodiments, the system further comprises a provisioning server. The provisioning server is configured to provision the second security element and comprises write authorisation to write to a memory area of the second security element.

The provisioning comprises:
receiving a public cryptographic key of the asymmetric key pair of the first security element,
validating the write authorisation of the provisioning server to write to the memory area of the second security element,
upon a successful validation of the write authorisation of the provisioning server, granting write access of the external provisioning server via the communication interface to the memory area of the second security element,
writing the public cryptographic key of the asymmetric key pair of the first security element into the memory area of the second security element.

According to embodiments, the system is configured to perform any of the previously described embodiments of the method for provisioning the second security element.

According to embodiments, the system further comprises an ID-provider server. The application program is an ID application program configured to manage one or more identity attributes stored in the mobile terminal and associated with the user. The ID-provider server is configured to provide and/or confirm one or more of the identity attributes of the user to a service-provider server and includes a read authorisation to read one or more of the identity attributes of the user. The providing and/or confirmation of one or more of the identity attributes of the user for a service-provider server comprises:
validating the read authorisation of the ID-provider server to read one or more of the identity attributes of the user,
upon successful validation of the read authorisation, sending one or more of the identity attributes of the user to the ID-provider server,
signing the sent one or more of the identity attributes of the user by the ID-provider server,
sending the signed one or more of the identity attributes of the user to the service-provider server.

According to embodiments, the system is configured to perform any of the previously described embodiments of the method for providing user attributes.

In the following, embodiments of the invention are explained in greater detail with reference to the drawings, in which:

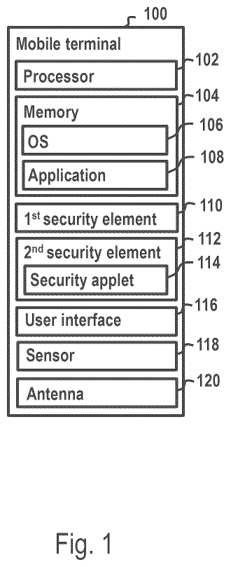

FIG. 1 shows a schematic diagram of an exemplary mobile terminal,

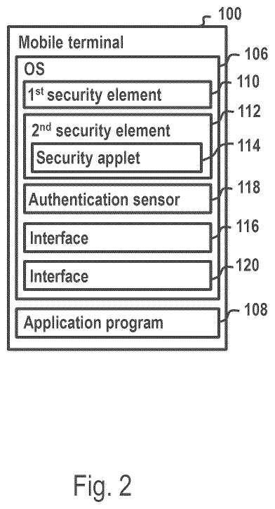

FIG. 2 shows a schematic diagram of an exemplary mobile terminal,

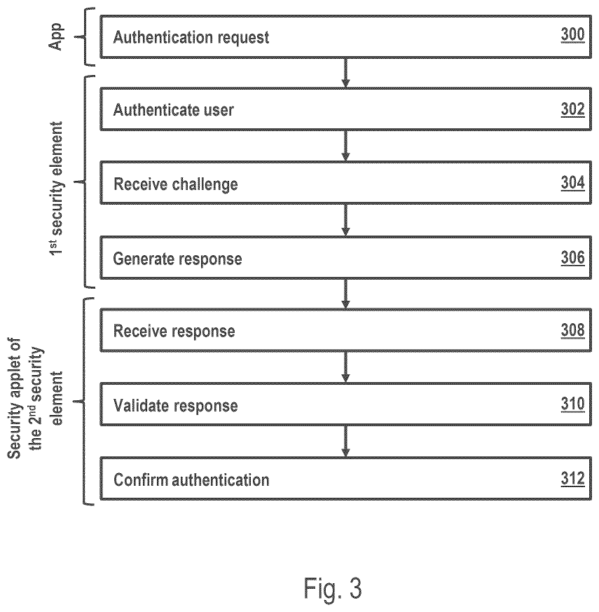

FIG. 3 shows a flowchart of an exemplary method for authenticating a user,

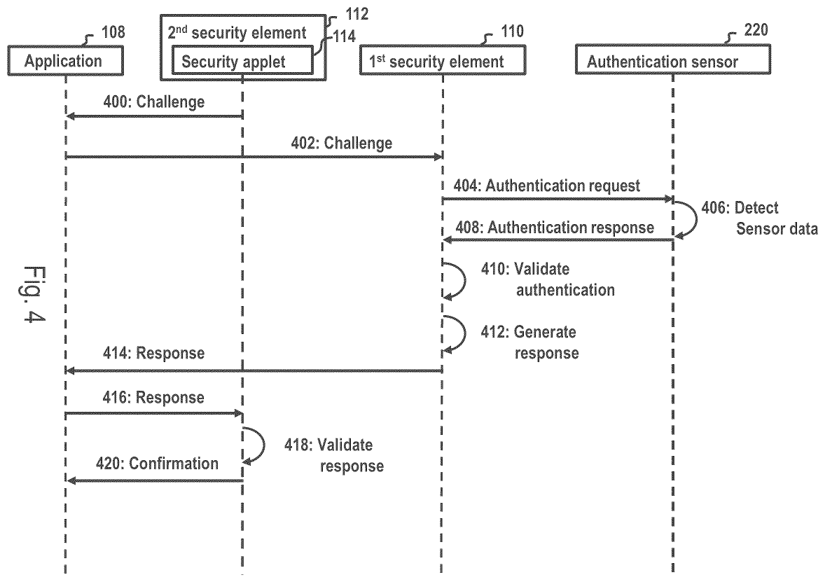

FIG. 4 shows a flowchart of an exemplary method for authenticating a user,

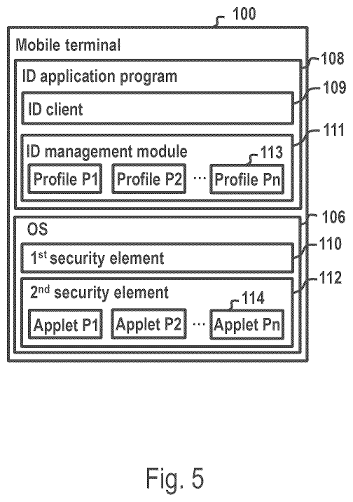

FIG. 5 shows a schematic diagram of an exemplary mobile terminal,

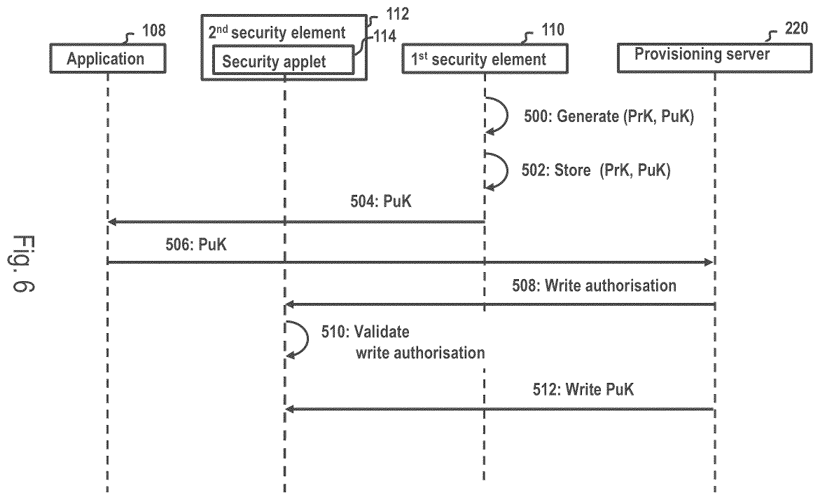

FIG. 6 shows a flowchart of an exemplary method for provisioning a public cryptographic key,

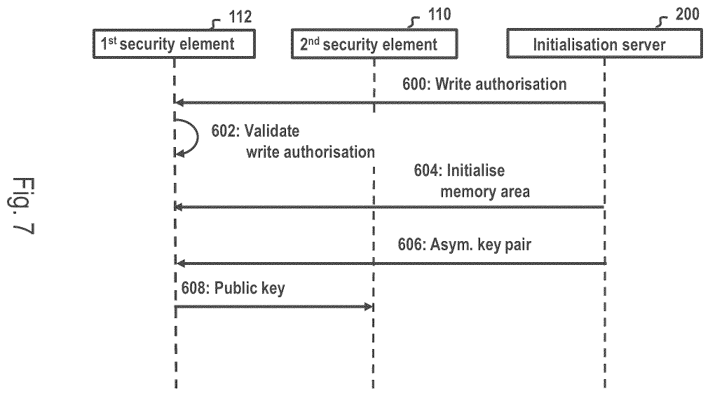

FIG. 7 shows a flowchart of an exemplary method for initialising a memory area of a security element, and

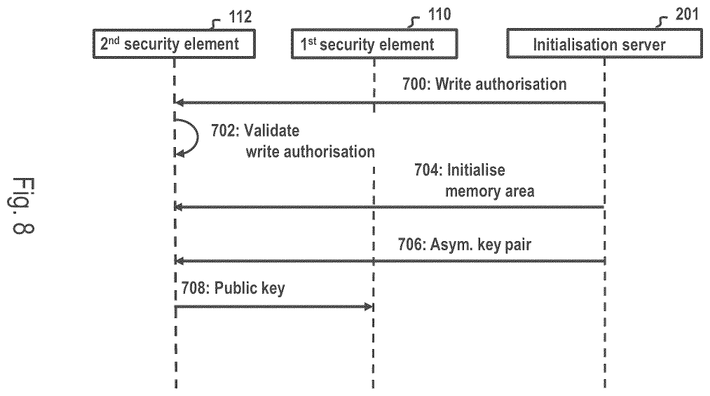

FIG. 8 shows a flowchart of an exemplary method for initialising a memory area of a security applet,

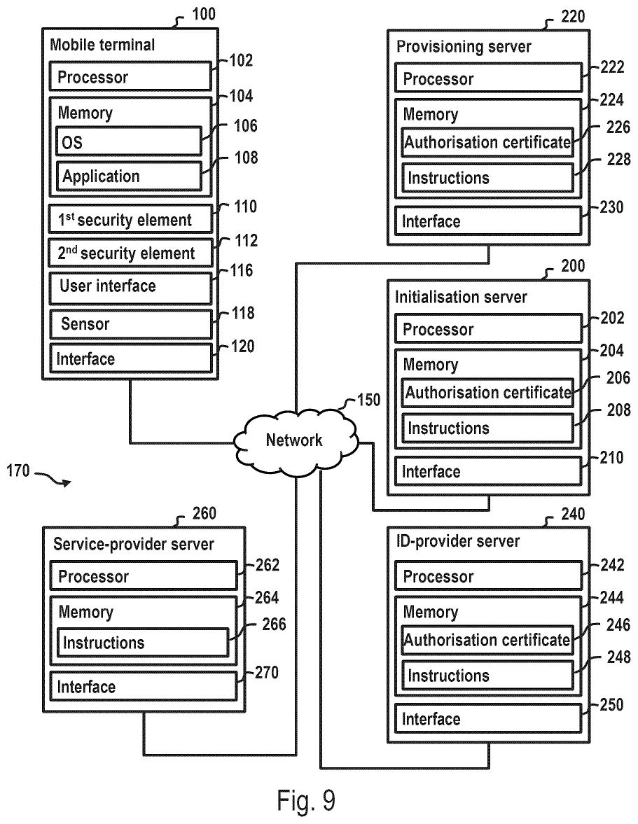

FIG. 9 shows a schematic diagram of an exemplary system, and

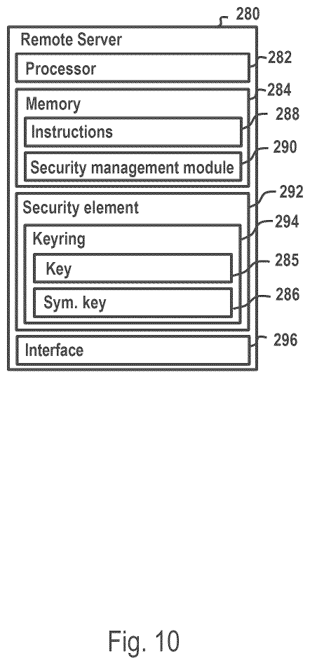

FIG. 10 shows a schematic diagram of an exemplary server which provides a remote security element.

Elements of the following embodiments which correspond to each other are marked by the same reference signs.

FIG. 1 shows an exemplary mobile terminal 100, for example a smartphone, which comprises a memory 104 with program instructions which are executed by a processor 102. The program instructions may comprise, for example, an operating system 106 installed on the mobile terminal 100 and an application program 108. Further, the mobile terminal comprises a first security element 110. For example, the mobile terminal 100 further comprises a second security element 112. For example, the security elements 110, 112 may each be implemented as an eSim and/or an eUICC. The first security element 110 is associated with and provides cryptographic means to the operating system, such as cryptographic keys, cryptographic functions and/or cryptographic protocols. For example, the first security element 110 provides a key store for storing cryptographic keys, such as symmetric, public and/or private cryptographic keys, and certificates, such as authorisation certificates, public key certificates and/or attribute certificates. The cryptographic means provided by the first security element 110 enabled the operating system 106 to execute or participate in a challenge response method. To this end, the cryptographic means comprise, for example, a private cryptographic key of an asymmetric key pair of the first security element stored in a protected memory area of the first security element. The corresponding private cryptographic key serves, for example, as a signature key for signing a challenge in the course of generating a response to the challenge.

For example, a security applet 114 associated with the application program 108 is installed on the second security element 112. This security applet 114 provides cryptographic means to the application program 108, such as cryptographic keys, cryptographic functions and/or cryptographic protocols. For example, the security applet 114, or a memory area of the second security element 112 associated with the security applet 114, provides a key store for storing cryptographic keys, such as symmetric public and/or private cryptographic keys, and certificates, such as authorization certificates, public key certificates, and/or attribute certificates. The cryptographic means provided by the second security element 112 enabled the application program 108 to execute or participate in a challenge response method. To this end, the second security element 112 and/or the security applet 114 of the security element has, for example, a public cryptographic key of the asymmetric key pair of the first security element. The corresponding public cryptographic key serves, for example, as a signature verification key for verifying a signature of a signed challenge received in response to the corresponding challenge in the course of a challenge response method.

Furthermore, the mobile terminal 100 comprises a user interface 116, which comprises, for example, a display, in particular a touchscreen. Using the user interface 116, the user may interact with the mobile terminal 100. For example, the user may be prompted to provide authentication data or authentication features. To capture authentication data from the user, the mobile terminal 100 comprises a sensor or authentication sensor 118, which may for example be integrated into the user interface 116 or implemented as a standalone component. The authentication data may comprise, for example, biometric data of the user, such as: fingerprint data, body geometry data/anthropometry data such as face, hand, ear geometry data, palm line structure data, vein structure data such as hand vein structure data, iris data, retina data, voice recognition data, nail bed pattern. For example, the authentication data may include knowledge of the user, such as a PIN or password. Furthermore, the authentication data may comprise, for example, behavioural characteristics or behavioural data of the user, such as movement data of the mobile terminal 100 caused by gross and/or fine motor movements of the user when carrying and/or using the mobile terminal 100. Appropriate authentication of the user may, for example, be a prerequisite for releasing identity attributes of the electronic identity for reading by a reading computer system. On the one hand, appropriate user authentication may ensure that the mobile terminal 100 is used by an authorised user. On the other hand, the provision of authentication data by the user may constitute consent by the user to the reading of the identity attributes of the electronic identity by the reading computer system. Lastly, the mobile terminal 100 comprises a communication interface or antenna 120 configured for wireless communication, for example via a network. For example, communication with the reading computer system may be via a network, such as an intranet or the Internet.

FIG. 2 shows an exemplary mobile terminal 100 on which an operating system 106 is installed that manages the resources of the mobile terminal 100 and makes them available to the application program 108. The managed resources comprise, for example, a first security element 110. Furthermore, the resources may comprise, for example, a second security element 112. In addition, the resources comprise the authentication sensor 118, the user interface 116, and the communication interface 120. In this regard, although the second security element 112 is provided or managed by, for example, the operating system 106, the security applet 114 comprised by the second security element 112 is associated with the application program 108, i.e. the security applet 114 provides cryptographic resources only to the application program 108. The operating system 106 is unable to use these cryptographic means. For cryptographic tasks, for example in the course of using the authentication sensor 118 or the communication interface 120, the first security element 110 with its cryptographic means is instead available to the operating system 106.

FIG. 3 shows an exemplary method for authenticating a user to an application program installed on a mobile terminal. In step 300, the application program (app) makes an authentication request to the operating system of the mobile terminal to authenticate the user of the mobile terminal. The operating system causes an authentication sensor of the mobile terminal to detect one or more authentication features of the user. In step 302, the user is authenticated using the first security element based on the captured authentication features. According to embodiments, the captured authentication features are compared with stored reference features. If there is a sufficient match between captured authentication features and stored reference features, authentication is successful. In step 304, the first security element receives a challenge from a challenge response method to confirm successful user authentication. The challenge comprises, for example, a nonce. According to embodiments, the challenge may be received before or after authentication. In particular, the authentication request may comprise the challenge. For example, the challenge is generated by the second security element and/or a security applet of the second security element and provided to the application program for executing the challenge response method. In step 306, the first security element generates a response. For this purpose, for example, the challenge is signed using a private cryptographic key of the first security element as a signature key. The corresponding private cryptographic key of the first security element is stored, for example, in a protected memory area of the first security element. The response is sent from the first security element, for example via the application program, to the second security element and/or the security applet of the second security element. In step 308, the second security element and/or the security applet of the second security element receives the response and validates it in step 310. The second security element and/or the security applet of the second security element has a public cryptographic key of the first security element as signature verification key for validating the response. To validate the response, the second security element and/or the security applet of the second security element decrypts the response. The result is, for example, a hash value of the challenge, which is compared with a hash value of the sent challenge. If the result of the decryption and the hash value of the sent challenge are identical, the challenge response method is successful. In step 312, the second security element and/or the security applet of the second security element confirms the successful authentication of the user, for example to the application program.

FIG. 4 shows an exemplary method for authenticating a user to an application program installed on a mobile terminal. In step 400, the second security element 112 and/or the security applet 114 on the second security element 112 sends a challenge, such as a nonce, to the application 108. In step 402, the application 108 sends the challenge to the first security element 110 in response to receipt thereof. The security element then initiates a user authentication. In step 404, an authentication request is sent to the authentication sensor 118. For example, an authentication prompt for the user is also displayed on a display device of the mobile terminal, such as a display. In step 406, authentication sensor data from the user is collected by the authentication sensor 118 and provided to the first security element in step 408 in response to the authentication request. In step 410, the authentication sensor data is validated using the first security element 110. If the validation and therefore the authentication is successful, a response to the challenge is generated by the first security element 110 in step 412. For this purpose, for example, the nonce of the challenge is signed with a private cryptographic key of the first security element, which is known only to the first security element 110. In step 414, the response is sent to the application program 108, which in step 416 forwards the response to the second security element 112 and/or the security applet 114 on the second security element 112 as a response to the challenge from step 400.

In step 418, the second security element 112 and/or the security applet 114 on the second security element 112 validates the received response. For example, the second security element 112 and/or the security applet 114 on the second security element 112 decrypts the response with a public cryptographic key of the first security element and compares the result with a hash value of the challenge sent in step 400. If both match, the validation is successful and a valid user authentication is successfully proven. In step 418, for example, an authentication confirmation is sent from the security applet 114 to the application program to confirm successful authentication.

FIG. 5 shows an exemplary mobile terminal 100 on which an application program 108 is stored, which is an ID application program. The ID application program manages identity attributes assigned to the user. For this purpose, it comprises an ID management module 111 with one or more ID profiles 113. Each of the ID profiles 113 is associated with an independent security applet 114 in the second security element 112. Each of the ID profiles 113 has associated therewith a set of one or more identity attributes. These identity attributes are, for example, each stored in a memory area of the second security element 112 associated with the corresponding security applet 114 and/or stored in encrypted form in a memory of the mobile terminal, wherein the cryptographic keys for decryption are each stored in the corresponding security applets 114. The ID application program 108 further comprises an ID client module 109 through which the ID application program 108 may receive, for example, requests for identity attributes of one of the ID profiles 113. In response to the request, for example by an ID provider service via a network, the ID application program 108 may provide the requested identity attributes subject to user consent. This may require user authentication to the ID application program 108, or may require proof of successful user authentication by the ID application program 108 using a challenge response method. For this purpose, a first security element 110 associated with the operating system 106 is used, from which a successful user authentication is confirmed with an authentication sensor 118 of the mobile terminal 100.

FIG. 6 shows a method for providing the asymmetric key in the first security element 110 and the security applet 114 for the challenge-response method. In step 500, the first security element 110 generates an asymmetric key pair comprising a private cryptographic key PrK and a public cryptographic key PuK, for example for use in the challenge-response method. In step 500, the first security element 110 stores the asymmetric key pair, wherein the private cryptographic key PrK is stored in a protected memory area of a memory of the first security element 110. The resulting public cryptographic key PuK is sent by the first security element 110 in step 504 to the application program 108, which in step 506 forwards the public cryptographic key PuK to a provisioning server 220 having write authorisation to write to a memory area of the second security element associated with the second security element and/or the security applet of the second security element. In step 508, the provisioning server 220 demonstrates its write authorisation, for example using an authorisation certificate and/or a cryptographic key provided therefor. In step 510, the write authorisation is validated. Upon successful validation of the write authorisation, the provisioning server 220 is granted write access to the memory area of the second security element, to which the provisioning server 220 writes the public cryptographic key PuK in step 512.

FIG. 7 shows a method for initialising the first security element 110 using an initialisation server 200. In step 600, the initialisation server 200 provides a write authorisation for initialising the security applet in the second security element, which is validated in step 602. The write authorisation may be proven, for example, by a corresponding authorisation certificate and/or a use of a cryptographic key provided for this purpose. The write authorisation is provided, for example, via a cryptographically secured communication link between the first security element 110 and the initialisation server 200, or in the course of establishing the corresponding cryptographically secured communication link or a cryptographically secured communication channel. The cryptographically secured communication link may, for example, be an end-to-end encrypted communication link. Upon successful validation, the initialisation server 200 is granted write access to the first security element 110 via the communication interface. In step 604, the initialisation server 200 initialises a memory area of the first security element 110 and, in step 606, writes an asymmetric key pair to the initialised memory area. Initialising the memory area comprises, for example, writing a file system to the corresponding memory area. In step 608, for example, the first security element 110 provides the public cryptographic key of the asymmetric key pair of the first security element 110 to the second security element and/or to a security applet 112 on the second security element. For example, providing the public cryptographic key may also be performed using a provisioning server 220, wherein the steps 504 to 512 shown in FIG. 6 are performed.

FIG. 8 shows a method for initialising a security applet in a (second) security element 112 using an initialisation server 201. In step 700, the initialisation server 201 provides a write authorisation for initialising the security applet in the second security element, which is validated in step 702. The write authorisation may be proven, for example, by a corresponding authorisation certificate and/or a use of a cryptographic key provided for this purpose. The write authorisation is provided, for example, via a cryptographically secured communication link between the second security element 112 and the initialisation server 201 or in the course of establishing the corresponding cryptographically secured communication link or a cryptographically secured communication channel. The cryptographically secured communication link may, for example, be an end-to-end encrypted communication link. Upon successful validation, the initialisation server 201 is granted write access to the second security element via the communication interface. In step 704, the initialisation server 201 initialises the memory area of the second security element 112 associated with the security applet and, in step 706, writes an asymmetric key pair to the initialised memory area. Initialising the memory area comprises, for example, writing a file system to the corresponding memory area. In step 708, for example, the security applet 112 provides the public cryptographic key of the asymmetric key pair to the first security element 110, for example via the application program.

FIG. 9 shows a system 170 comprising a mobile terminal 100 connected via a network 150, e.g. the Internet, to an initialisation server 200, a provisioning server 220, an ID-provider server 240 and/or a service-provider server 260. The mobile terminal 100 is the mobile terminal 100 shown in FIG. 1.

The initialisation server 200 comprises a processor 202, a memory 204 and a communication interface 210. The memory 204 stores program instructions 208, upon execution of which the processor 202 controls the initialisation server 200 to initialise the first security element 110 of the mobile terminal 100, for example according to the method in FIG. 7. The initialisation server 200 uses, for example, the authorisation certificate 206 to prove a write authorisation to initialise the security applet. Furthermore, another initialisation server 201 configured similarly to the initialisation server 200 may be used, for example, to initialise the second security element 112 and/or a security applet in the second security element 112 of the mobile terminal 100, for example in accordance with the method in FIG. 8.

The provisioning server 220 comprises a processor 222, a memory 224, and a communication interface 230. The memory 204 stores program instructions 228, upon execution of which the processor 222 controls the provisioning server 220 to provide a public cryptographic key of the first security element 110 for challenge response in the second security element and/or in a security applet of the second security element 112, for example, according to the method in FIG. 6. To prove a write authorisation to write the public cryptographic key of the first security element 110 into the second security element and/or into the security applet of the second security element 112, the provisioning server 220 uses, for example, the authorisation certificate 226.

The service-provider server 260 comprises a processor 262, a memory 264 and a communication interface 270. The memory 264 stores program instructions 268, upon execution of which the processor 262 controls the service-provider server 260 to provide services that may be requested and/or used, for example, by the mobile terminal 100 via the network 170. A request for services from the service-provider server 260 requires, for example, provision and/or proof of one or more identity attributes of the user. Upon a request for a service of the service-provider server 260 by the mobile terminal 100, the service-provider server 260 sends an identity attribute request for identity attributes of the user of the mobile terminal 100 to an ID-provider server 240. The identity attribute request may be sent by the service-provider server 260 to the ID-provider server 240, for example, directly or via the mobile terminal 100.

The ID-provider server 240 comprises a processor 242, a memory 244, and a communication interface 250. The memory 244 stores program instructions 248, upon execution of which the processor 242 causes the service-provider server 240 to read the identity attributes specified in the identity attribute request from a memory of the mobile terminal 100. To do this, the ID-provider server 240 establishes a cryptographically secure communication channel with the mobile terminal 100. The one cryptographically secured communication channel may, for example, be an end-to-end encrypted communication channel. For example, this requires mutual authentication between the ID-provider server 240 and the mobile terminal 100. For read access to the identity attributes, the ID-provider server 240 uses an ID application program 108 on the mobile terminal 100 that manages the identity attributes. The ID-provider server 240 proves a read authorisation for reading the identity attributes specified in the identity attribute request, for example, with the authorisation certificate 248. Furthermore, a read access of the ID-provider server 240 to the identity attributes specified in the identity attribute request requires a consent of the user of the mobile terminal 100. To do this, the user must successfully authenticate to the ID application program 108, for example using the method of FIGS. 3 and 4. For example, a user interface display device 116 indicates to the user which identity attributes are to be sent to the ID-provider server 240 and allows the user to edit this selection. For example, the user may select which of the requested identity attributes are actually sent. Upon successful proof of read authorisation and successful user authentication, the released identity attributes are sent to the ID-provider server 240. The ID-provider server 240 signs the received identity attributes and sends them to the service-provider server 260.

FIG. 10 shows an exemplary external server 280 that provides a remote second security element 292 for use by a mobile terminal or an electronic identity managed by an application on the mobile terminal via a network. For example, the server 280 further comprises a processor 282, a memory 284, and a communication interface 296. The memory 284 stores program instructions 288 for reading identity attributes stored on the mobile terminal managed by the application. The identity attributes to be read are provided to a reading computer system. Upon execution of the program instructions 288, the processor 202 controls the security management service server 240 to, for example, receive the identity attributes to be read out from the application using the communication interface 296. The identity attributes are encrypted using a cryptographic key associated with the electronic identity. The security element 292 has a cryptographic key 285 for decrypting the identity attributes. For example, in the case of symmetric encryption, the cryptographic key 285 is the corresponding symmetric key. In the case of asymmetric encryption, the identity attributes are encrypted with, for example, a public cryptographic key, the corresponding private cryptographic key of which is stored as the cryptographic key 285 in the remote security element 292. The remote security element 292 decrypts the identity attributes to be read out using cryptographic key 285. Further, the remote security element 292 encrypts the decrypted identity attributes to be read out using an ephemeral symmetric cryptographic key 286 stored in the remote security element 292. The remote security element 292 shares this ephemeral symmetric cryptographic key 286 with, for example, the reading computer system for communication encryption. Lastly, the server 280 sends the encrypted identity attributes to be read out to the reading computer system using the communication interface 296. For example, the server 280 sends the encrypted identity attributes to be read out to the mobile terminal for forwarding to the reading computer system.

For example, the remote security element 292 comprises a keyring 294 associated with the application and/or the electronic identity. The keyring 294 provides identity-specific cryptographic keys to the application 108 for the electronic identity it manages. Further, the remote security element 292 comprises, for example, further cryptographic means, such as cryptographic functions and/or cryptographic protocols, which the remote security element makes available for use by the application or the electronic identity. For example, the keyring 294 is provided by means of a key store for storing cryptographic keys for the individual electronic identity, such as symmetric public and/or private cryptographic keys, and certificates, such as public key certificates and/or attribute certificates. For example, the cryptographic means provided by the remote security element 292 enabled the application 108, using the keyring 294 with the identity-specific cryptographic keys, to encrypt and/or decrypt data for the electronic identity managed by the application 108, and to create and/or verify signatures. For example, the cryptographic means provided by the remote security element 292 enable the application 108 to execute or participate in a challenge response method for the electronic identity it manages. In particular, the cryptographic means comprise the application 108 for example a public cryptographic key of the first security element of the mobile terminal. The security element 292 may be implemented, for example, as a hardware security module. A hardware security module refers to an internal or external peripheral device that enables efficient and secure execution of cryptographic operations and/or applications. Cryptographic keys used by the security module are stored on it, for example, both in software and protected against physical or side-channel attacks.

For example, the server 280 further comprises a security management program module 290 of a security management service managing the security element 292. For example, the server 280 is a server of the security management service or a stand-alone server. For example, the security management service provides the applet 294 for installation in the security element 294. For example, the server 280 comprises a plurality of security elements 292, each of which is managed by an individual security management service. For each of the security elements 292, for example, a security management program module 290 is installed on the server 280. For example, the server 280 comprises exactly one security element 292 or exclusively security elements 292 managed by the same security management service. For example, a plurality of servers 280 are provided that are associated with different security management services and exclusively comprise security elements 292 managed by the same security management service to which the corresponding server 280 is associated.

### LIST OF REFERENCE SIGNS

100 mobile terminal
102 processor
104 memory
106 operating system
108 application program
109 ID client
110 first security element
111 ID management module
112 second security element
113 ID profile
114 security applet
116 user interface
118 authentication sensor
120 communication interface
150 network
170 system
200 initialisation server
201 initialisation server
202 processor
204 memory
206 authorisation certificate
208 program instructions
210 communication interface
220 provisioning server
222 processor
224 memory
226 authorisation certificate
228 program instructions
230 communication interface
240 ID-provider server
242 processor
244 memory
246 authorisation certificate
248 program instructions
250 communication interface
260 service-provider server
262 processor
264 memory
266 program instructions
270 communication interface
280 server
282 processor
284 memory
285 cryptographic key
286 symmetric key
288 program instructions
290 security management program module
292 security element
294 keyring
296 communication interface

1. A method for authenticating a user to an application program installed on a mobile terminal, wherein an operating system is installed on the terminal, wherein the operating system is configured to control at least one authentication sensor of the terminal for detecting at least one authentication factor of the user, wherein the terminal comprises a first security element associated with the operating system, wherein the first security element comprises cryptographic means for executing a challenge-response method, wherein a private cryptographic key of an asymmetric key pair of the first security element is stored in a protected memory area of the first security element,
wherein there is further provided a security element associated with the application program, which is independent of the first security element, wherein the second security element comprises cryptographic means for executing a challenge response method,
wherein the method comprises:
in response to an authentication request from the application program, authenticating the user by the operating system using the authentication sensor and the first security element,
executing a challenge-response method between the first security element and the second security element, wherein the challenge-response method comprises generating a response by the first security element and validating the response by the second security element, wherein generating the response comprises encrypting a challenge of the second security element by the first security element using the private cryptographic key of the first security element, and wherein validating the response comprises decrypting the response of the first security element by the second security element using a public cryptographic key of the asymmetric key pair of the first security element, wherein successful execution of the challenge-response method confirms successful authentication of the user by the operating system,
upon successful execution of the challenge-response method, confirming successful authentication of the user to the application program by the second security element.

2. The method according to claim 1, wherein the second security element comprises a certificate comprising the public cryptographic key of the asymmetric key pair of the first security element.

3. The method according to claim 2, wherein the certificate is a certificate of a public key infrastructure.

4. The method according to claim 1, wherein the terminal comprises the second security element.

5. The method according to claim 1, wherein the second security element provided by an external server.

6. The method according to claim 1, wherein the second security element comprises a security applet associated with the application program,
wherein the security applet comprises the cryptographic means for executing a challenge-response method,
wherein the successful authentication of the user to the application program is confirmed by the security applet.

7. The method according to claim 1, wherein the method further comprises providing the asymmetric key pair of the first security element.

8. The method according to claim 7, wherein providing the asymmetric key pair of the first security element comprises:
generating the asymmetric key pair by the first security element,
transmitting the public cryptographic key of the asymmetric key pair of the first security element to the second security element.

9. The method according to claim 8, wherein the mobile terminal comprises a communication interfaces for communicating via a network, wherein transmitting the public cryptographic key of the asymmetric key pair of the first security element comprises:
sending the public cryptographic key of the asymmetric key pair of the first security element from the first security element to the application program,
forwarding the public cryptographic key of the asymmetric key pair of the first security element from the application program using the communication interface via the network to an external provisioning server having write authorisation to write to a memory area of the second security element,
validating the write authorisation of the provisioning server to write to the memory area of the second security element,
upon successful validation of the write authorisation of the provisioning server, granting write access of the external provisioning server via the communication interface to the memory area of the second security element,
writing the public cryptographic key of the asymmetric key pair of the first security element into the memory area of the second security element.

10. The method according to claim 7, wherein the asymmetric key pair of the first security element is provided in the course of initialising the first security element by an external initialisation server, wherein the initialisation server comprises a write authorisation to initialise the first security element,
wherein the initialisation comprises:
generating the asymmetric key pair of the first security element by the first security element,
validating the write authorisation of the initialisation server to initialise the second security element,
upon successful validation of the write authorisation of the initialisation server, granting a write access of the external initialisation server via the communication interface to the second security element,
initialising the first security element,
writing the asymmetric key pair of the first security element into the initialised memory area.

11. The method according to claim 10, wherein the method further comprises:
sending the public cryptographic key of the asymmetric key pair of the first security element from the external initialisation server the external provisioning server, which has write authorisation to write to a memory area of the second security element,
validating the write authorisation of the provisioning server to write to the memory area of the second security element,
upon successful validation of the write authorisation of the provisioning server, granting write access of the external provisioning server via the communication interface to the memory area of the second security element,
writing the public cryptographic key of the asymmetric key pair of the first security element into the memory area of the second security element.

12. The method according to claim 1, wherein communication in the course of the challenge-response method between the first security element and the second security element takes place via the application program.

13. The method according to claim 12, wherein the challenge-response method comprises:
sending the challenge of the second security element to the application program,
forwarding the challenge from the application program to the first security element,
upon successful authentication of the user by the operating system, generating the response by the first security element,
sending the response from the first security element to the application program,
forwarding the response from the application program to the second security element,
validating the decrypted response by the second security element.

14. The method according to claim 1, wherein the authentication request comprises the challenge and the response is generated upon successful authentication of the user.

15. The method according to claim 1, wherein authentication of the user comprises:
detecting at least one authentication factor of the user using the authentication sensor,
validating the detected authentication factor using the first security element.

16. The method according to claim 1, wherein confirming successful authentication of the user comprises sending an authentication confirmation of the second security element to the application program upon successful validation of the response.

17. The method according to claim 1, wherein the application program is an ID application program configured to manage one or more identity attributes associated with the user.

18. The method according to claim 17, wherein the ID application program is configured to send one or more of the identity attributes of the user to another terminal.

19. The method according to claim 17, wherein the ID application program is configured to send one or more of the identity attributes of the user using the communication interface via a network to an ID-provider server for providing said attributes to a service-provider server and/or for confirmation by the service-provider server.

20. The method according to claim 17, wherein the ID application program comprises an ID management module that manages a plurality of ID profiles, wherein each of the ID profiles is associated with an independent security applet in the second security element.

21. The method according to claim 20, wherein each of the ID profiles is associated with a set of one or more identity attributes.

22. A system, wherein the system comprises a mobile terminal for authenticating a user to an application program installed on a mobile terminal, wherein the mobile terminal comprises a processor, wherein an operating system is installed on the terminal, wherein the operating system is configured to control at least one authentication sensor of the terminal for detecting at least one authentication factor of the user, wherein the terminal comprises a first security element associated with the operating system, wherein the first security element comprises cryptographic means for executing a challenge-response method, wherein a private cryptographic key of an asymmetric key pair of the first security element is stored in a protected memory area of the first security element,
wherein the system further comprises a second security element independent of the first security element, wherein the second security element comprises cryptographic means for executing a challenge-response method,
wherein the processor is configured to execute a method for authenticating a user to an application program installed on a mobile terminal, the method comprising:
in response to an authentication request from the application program, authenticating the user by the operating system using the authentication sensor and the first security element,
executing a challenge-response method between the first security element and the second security element, wherein the challenge-response method comprises generating a response by the first security element for validation by the second security element, wherein generating the response comprises encrypting a challenge of the second security element by the first security element using the private cryptographic key of the first security element for validation by decrypting the response of the first security element by the second security element using a public cryptographic key of the asymmetric key pair of the first security element, wherein successful execution of the challenge-response method confirms successful authentication of the user by the operating system,
upon successful execution of the challenge-response method, confirming successful authentication of the user to the application program by the second security element.

23. The system according to claim 22, wherein the terminal comprises the second security element.

24. The system according to claim 22, wherein the terminal comprises a communication interface for communicating via a network, wherein the system further comprises a server providing the second security element.

25. The system according to claim 22, wherein the system further comprises an initialisation server, wherein the initialisation server is configured to initialise the first security element and comprises a write authorisation to initialise the first security element, wherein the initialising comprises:
generating the asymmetric key pair of the first security element by the first security element,
validating the write authorisation of the initialisation server to initialise the second security element,
upon successful validation of the write authorisation of the initialisation server, granting write access of the external initialisation server via the communication interface to the second security element,
initialising the first security element,
writing the asymmetric key pair of the first security element into the initialised memory area.

26. The system according to claim 22, wherein the system further comprises a provisioning server, wherein the provisioning server is configured to provision the second security element and comprises write authorisation to write to a memory area of the second security element, wherein the provisioning comprises:
receiving a public cryptographic key of the asymmetric key pair of the first security element,
validating the write authorisation of the provisioning server write to the memory area of the second security element,
upon successful validation of the write authorisation of the provisioning server, granting write access of the external provisioning server via the communication interface to the memory area of the second security element,
writing the public cryptographic key of the asymmetric key pair of the first security element into the memory area of the second security element.

27. The system according to claim 22, wherein the system further comprises an ID-provider server, wherein the application program is an ID application program configured to manage one or more identity attributes stored in the mobile terminal and associated with the user, wherein the ID-provider server is configured to provide and/or confirm one or more of the identity attributes of the user to a service-provider server and comprises a read authorisation to read one or more of the identity attributes of the user, the providing and/or confirmation of one or more of the identity attributes of the user for a service-provider server comprising:
validating the read authorisation of the ID-provider server to read one or more of the identity attributes of the user,
upon successful validation of the read authorisation, sending one or more of the identity attributes of the user to the ID-provider server,
signing of the sent one or more of the identity attributes of the user by the ID-provider server,
sending the signed one or more of the identity attributes of the user to the service-provider server.
